(19) United States
(12) Patent Application Publication
(10) Pub. No.: US 2011/0139467 A1
(43) Pub. Date: Jun. 16, 2011

(54) SHOCK-ABSORBING HORSESHOE

(76) Inventors: Helge Moller, Charlottenlund (DK); Peter Flarup, Karlebo (DK); Anders Moesgaard, Klampenborg (DK)

(21) Appl. No.: 12/991,723

(22) PCT Filed: May 19, 2008
(86) PCT No.: PCT/DK08/50114

§ 371 Date: Feb. 1, 2011

(51) Int. Cl. A01L 1/04; A01L 7/02

(52) U.S. Cl. 168/12

(57) ABSTRACT

The shock-absorbing horseshoe comprises a rigid part (1) for abutment with a hoof of a horse, said rigid part forming one rigid body with two backward facing branches (3,4). A lower section (9, 10) of each backward facing branch is shorter than an upper section (11, 12), and a resilient part (13, 14) extends backward beyond rear edges of each said lower section and ends at rear edges of said upper section.

The present invention relates in a first aspect to a shock-absorbing horseshoe comprising a rigid part for abutment with a hoof of a horse, said rigid part forming one rigid body with two backward facing branches.

Horseshoes implementing a resilient part to shock-absorb the impact between the horseshoe and the substratum are well known in the art. Such prior art shoes comprise a hoof contacting plate, a ground contacting plate and an elastic or resilient layer interposed between the plates. The ground contacting plate and, possibly, the elastic layer are provided with holes large enough for a nail to be inserted through them, the hoof contacting plate being provided with smaller holes to let the nail abut the hoof contacting layer or the interposed elastic layer.

EP 1389422 discloses a shock-absorbing horseshoe of the type defined in the opening paragraph in which a resilient intermediate layer completely fills out the space between an upper part and a lower part, the lower part being shorter than the upper part. Nail holes in the horseshoe are manufactured by positioning of core elements during moulding of the intermediate layer. Securing of the horseshoe to the hoof by means of conventional nails is accomplished by guiding the nails through the nail holes and into the hoof, the nail heads abutting against the resilient intermediate layer. The two parts of the horseshoe is kept together by a combination of a rigid mechanical connection solely at the front of the horseshoe and an adhering force from the resilient intermediate layer.

The upper and lower parts are cut from a plate of steel. A high steel strength has proven to be necessary in order to ensure structural integrity of the horseshoe. The steel strength needs to be so high that it is virtually impossible to carry out the usually necessary cold-deformation of the horseshoe when shoeing a horse.

Further, the front edge of the horseshoe is subjected to wear due to deflection of the two parts, and this may entail the destruction of the horseshoe by breaking up into parts. This breaking up is even more pronounced when a soft and thus more comfortable intermediate layer material is used, because the more soft a material, the more the rigid mechanical connection at the front of the horseshoe is subjected to stresses. This induces material fatigue in that part of the horseshoe, and the lower part of the horseshoe might break off.

Providing a further means of keeping the two parts together entails a problem. DK 19284, U.S. Pat. 918,094 and U.S. Pat. 918,094 suggest using screws or bolts to improve the structural stability of the three layers. In DK-C-19284 the resilient intermediate layer is positioned as a resilient ring around each bolt between the under part and the upper part. During use of the horseshoe, there is a strong possibility that the heads of the screws, bolts or nails will extend through the hoof of the horse and into softer body parts. This is of course very undesirable.

To avoid this problem, in EP 1389422 a rivet connects an upper and a lower part of a horseshoe, the rivet at its side facing the hoof abutting a cushion made from a resilient material.

However, despite many suggestions in recent years none of the prior art solutions have proven satisfactory regarding the structural integrity of the horseshoe. Use of fastening means such as bolts, rivets or screws only slightly prolong lifetime of the horseshoe. The three-layer construction of the shock-absorbing horseshoes has proved very hard to provide with sufficient stability. During use, such horseshoes still tend to break up into parts and, for this reason, still have not won significant market shares.

In view of this prior art, the object of the present invention is to provide a shock-absorbing horseshoe of the type stated in the introduction, which has improved structural integrity, longer lifetime and does not tend to break up into pieces.

To meet this object the horseshoe is characterized in that a lower section of each backward facing branch is shorter than an upper section, and a resilient part extends backward beyond rear edges of each said lower section and ends at rear edges of the respective upper section.

The inventors of the present invention have discovered that the structural stability problems of the prior art shock-absorbing horseshoes seem to be due to a fundamental flaw in the three-layer design of the prior art. Multiple prior attempts to solve these problems having not resulted in anywhere near satisfactory results, the inventors have developed an alternative solution dispensing with the three-layer structure of the prior art.

Thus, it has been discovered that the main shock-absorbing effect is achieved by providing resilience at the backward or heel part of the horseshoe. Providing a resilient part at this position, the resilient part abutting the ground during use has proven to provide satisfactory shock absorption or dampening. This is believed to be due to the fact that during running the hoof “heel” hits the ground initially and with the greatest force.

This further allows for the remaining part of the shoe to be formed as one rigid body corresponding in structural integrity to more conventional and widely used horseshoes. Also, the resilient part can be manufactured as a more stable entity and can be readily secured to the rigid part.

Manufacture of the horseshoe of the present invention can be carried out at a competitive price and with a safe securing of the shoe to the hoof without any risk that the individual parts of the shoe will fall apart during use. The solution of the present invention furthermore does not involve any increased risk of damaging the horse.

In a preferred embodiment of the first aspect of the invention said rigid part is a solid, integrally formed body, providing for an improved structural integrity of the horseshoe.

In another embodiment said rigid part in each said upper section above the respective resilient part comprises cut-outs forming barbs adapted for firmly retaining said resilient parts to each said upper section.

In another embodiment each said resilient part is wedge-shaped, a lower surface of each said resilient part at each said rear edges of said lower sections being in alignment with an underside of said lower sections and extending downward and backward toward said rear edges of said upper sections. Such backwardly inclined resilient parts ensure that the impact of the hoof with the ground is on the resilient parts. Further, the resilient parts are provided with greater resilience. In a further development of this embodiment each said lower side of said resilient parts extends downward in an angle of 2-10°, preferably 3-6°, more preferred about 4°, in relation to said underside of the respective lower section. Such dimension of the backwardly inclining resilient parts has proven optimal regarding impact with the ground without disturbing the balance of the horse.

In a further embodiment said resilient parts comprise a moulded resilient plastic material, preferably polyurethane. Resilient plastics and rubbers have good working properties and may by moulding be brought to adhere well to the surfaces of the rigid part. Polyurethane (P) has in particular turned out to be a suitable material as it in tests has proven to be a well performing resilient and durable material in this connection.

In a second aspect the present invention provides a set of parts adapted to be assembled to form a shock-absorbing horseshoe, comprising a rigid part adapted for abutment with a hoof of a horse and with the ground, said rigid part forming one rigid body with two backward facing branches and having a number of openings extending from a lower to an upper surface of said rigid part, characterized by further comprising a number of resilient nail retainers adapted to be embedded in said openings of said rigid part, each nail retainer comprising at least one nail hole and being arranged to form an intermediate resilient layer between a nail guided through said nail hole and said rigid part.

The inventors of the present invention have discovered that oscillations or shocks from impact of a horseshoe attached to a horse's hoof by means of nails travel or are distributed into the hoof through the nails. Thus, it has surprisingly been found that a significant contribution to the impact and wear on the leg parts of the horse can be avoided by means of resilient nail retainers embedded in the rigid part of the horseshoe. The resilient nail retainers form a resilient layer between the nails and the rigid part of the horseshoe, providing significant dampening of the effects to the hoof and other leg parts of the horse of the impact of the horseshoe with the substratum.

In a preferred embodiment of the second aspect of the invention said nail retainers are arranged such that a nail can be connected to a hoof of a horse through one said nail hole without being in contact with any portion of said rigid part. This provides for an optimal dampening of impact forces exerted on the horseshoe.

In another embodiment said nail retainers comprise a moulded resilient plastic material, preferably polyurethane. As has been described above in relation to the first aspect of the invention polyurethane (P) has in particular turned out to be a suitable material as it in tests has proven to be a well performing resilient and durable material in this connection.

In another embodiment said openings in said rigid part and said nail retainers follow a curvature of said horseshoe.

In another embodiment each nail retainer comprises a section for abutting a head of a nail, said section preferably being sunk in said nail retainer. This ensures that impact oscillations travelling from the rigid part of the horseshoe, through the nail heads and the nails and thus into the hoof are significantly dampened.

In another embodiment said nail retainers are embedded in said openings. In a further development of this embodiment said horseshoe is according to an embodiment of the first aspect of the invention, said resilient parts and nail retainers preferably being manufactured from the same resilient material. This embodiment has the advantage of providing the possibility to form the resilient parts and the nail retainers in the same process while providing optimal shock-dampening effects.

In another embodiment said horseshoe, besides said resilient parts and said nail retainers, does not comprise any resilient elements. This ensures maximum durability of the horseshoe.

The invention will be explained in detail in the following by means of examples of embodiments with reference to the schematic drawing, in which

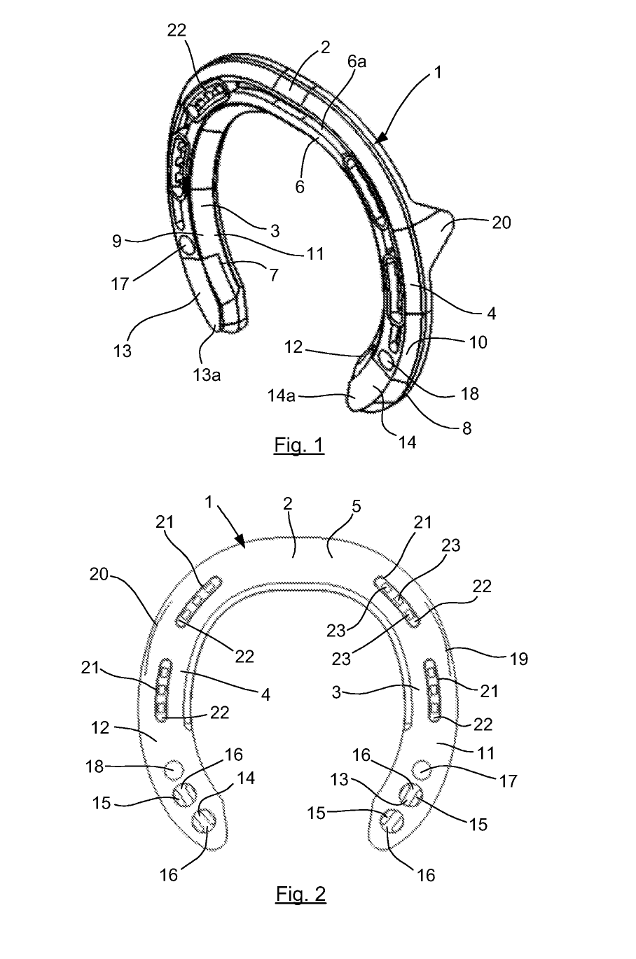

FIG. 1 is a perspective view of an embodiment of a shock-absorbing horseshoe according to the first aspect of the invention, said horseshoe also forming a set of parts according to the second aspect of the invention,

FIG. 2 is a top view of the horseshoe shown in FIG. 1,

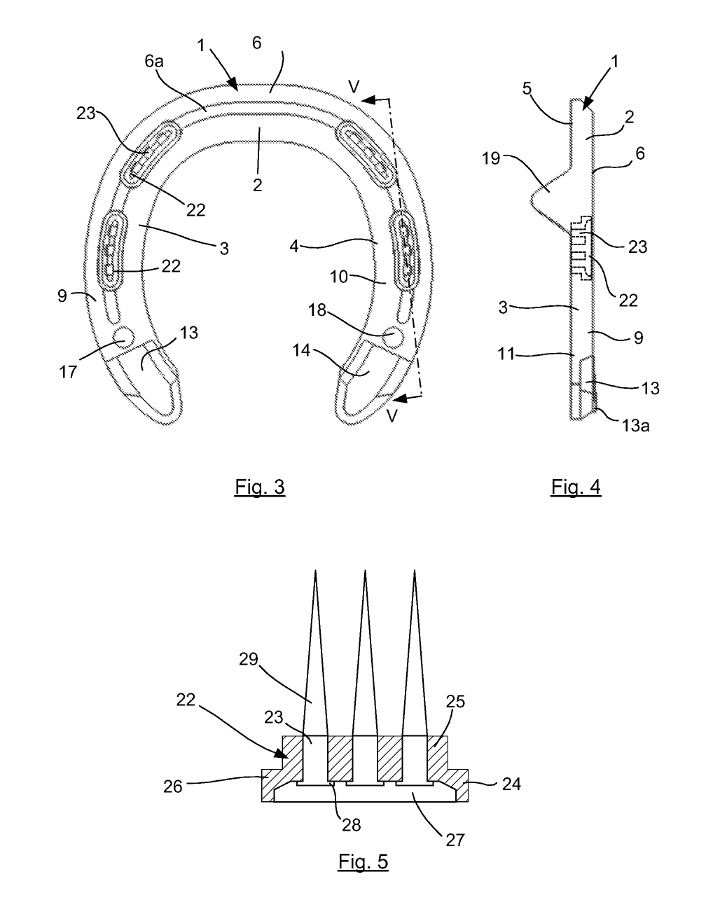

FIG. 3 is a bottom view of the horseshoe shown in FIG. 1,

FIG. 4 is a side view of the horseshoe shown in FIG. 1, and

FIG. 5 is a sectional view taken along the line V-V of FIG. 3 of a nail retainer of the horseshoe shown in FIG. 1.

FIGS. 1-4 are different views of an embodiment of a shock-absorbing horseshoe according to the first aspect of the invention, said horseshoe also forming a set of parts according to the second aspect of the invention. In all four views the horseshoe is shown with a front end upward; the front end is in the present context to be understood as facing forward, i.e. towards the head of a horse to which the shoe is to be attached.

A rigid part 1 of the horseshoe is shaped substantially as a conventional horseshoe according to a hoof of a horse (not shown) with a front portion 2 coherent with two backward (i.e. towards a tail of the horse) facing branches 3, 4. When shoed to a horse an upper surface 5 of the rigid part 1 abuts the hoof of the horse, and a lower surface 6 is brought into impact with the ground or substratum on which the horse moves. The rigid part 1 forms a solid, integrally formed main shoe body and may be made from any suitable material having a suitable rigidity and wear resistance, cf. also below. Typically, metal with good wear resistance and good cold working properties like for instance steel is chosen.

Cut-outs 7, 8 of the rigid part 1 are formed at the end of each branch 3, 4 such that lower sections 9, 10, respectively, of each backward facing branch 3, 4 are shorter than upper sections 11, 12, respectively, measured in the backward direction. Respective resilient parts 13, 14 extend backward beyond rear edges of the lower sections 9, 10 and end at rear edges of the upper section 11, 12.

In the present specification the term “rigid” is used as meaning “high stiffness” and is, with regard to the rigid part 1, to be understood such that Young's modulus E of the part is relatively high in relation to the resilient material of the resilient parts 13, 14 (and in relation to the resilient nail retainers 22, cf. below), which have a comparatively low Young's modulus. Generally, the proportion of E of the rigid part 1 in relation to E of the resilient parts 13, 14 is preferably at least 100, more preferably at least 200 and most preferred at least 400. On the other hand, E of the rigid part 1 should not be too high (in absolute terms) because the oscillation frequency of the rigid part increases with E, a high oscillation frequency worsening the effect on the horse of oscillations. Also, a higher value of E makes it harder to cold-deform the horseshoe when shoeing the horse. Preferably, E of the rigid part 1 lies within an interval of 80-250 GPa, more preferably 100-200 GPa and most preferred 150-175 GPa. Preferably, E of the resilient parts 13, 14 (and the nail retainers 22, cf. below) is 10-700 MPa, more preferably 100-400 MPa and most preferred 200-300 MPa. In the present embodiment the resilient parts 13, 14 are moulded from a resilient plastic material, preferably polyurethane, the proportion of E of the rigid part 1 (made from steel) in relation to E of the resilient parts 13, 14 (made from polyurethane) being above 400. The yield strength of the material of the rigid part 1 should be in an interval of about 235-255 N/mm², preferably about 245 N/mm². In the present context the values of Young's modulus E and the yield strength are to be considered when measured under conditions relating to strain, temperature etc. as would occur during ordinary use of the horseshoe (i.e. when shoed on a horse).

As is best seen in FIG. 4, each resilient part 13, 14 is slightly wedge-shaped. A lower surface 13a, 14a of each resilient part 13, 14 is at the rear edges of the respective lower section 9, 10 in alignment with an underside of the respective lower section 9, 10, the respective lower surface 13a, 14a extending downward and backward toward the rear edges of the respective upper section 11, 12. In the embodiment of the drawings the resilient parts 13, 14 extend downward in an angle of about 4° in relation to the underside of the lower sections 9, 10.

By providing the resilient parts 13, 14 at the rear edges of the backward facing branches 3, 4, a shock-absorbing effect is obtained in the rear part of the horseshoe, which is the part of the horseshoe first hitting the substratum.

The thickness of each resilient part 13, 14 is defined as the distance between a lower surface and an upper surface of the respective resilient part. It has proven advantageous that this thickness is 1.25-2.5 times larger than the thickness of the parts of the upper sections 11, 12 of the rigid part 1. Preferably, however, this ratio between the thicknesses lies in an interval of 1.5-2.0, most preferred about 1.7. Further, it has proven advantageous that from the rear edge of the horseshoe the resilient part extends 0.15-0.4, preferably about 0.25 of the linear distance from the rear edge to the front edge of the horseshoe. These dimensions provide for an optimum shock-absorbing effect combined with structural integrity of the horseshoe.

In the backward facing branches 3, 4 of the horseshoe respective holes 17, 18 are provided for the possibility of providing a modax (not shown) to enable the horse to stand firmly on a slippery or loose substratum such as ice or snow or in connection with riding in rough terrain.

The rigid part 1 is at a front section of the branches 3, 4 provided with respective conventionally formed, upward extending toe clips 19, 20 serving as abutment for the edges of a hoof.

As is seen best in FIG. 3, in the lower surface 6 of the rigid part 1 a slot 6a extends substantially from one resilient part 13 through the curved shape of the rigid part 1 to the other resilient part 14. As is seen best in FIG. 2, four openings 21 extend through the rigid part 1 from the lower surface 6, more specifically from the bottom of the slot 6a, to the upper surface 5 of the rigid part 1. In the four openings 21 four resilient nail retainers 22 are embedded. The nail retainers 22 are uniformly shaped and each comprises three nail holes 23. The openings 21 and the nail retainers 22 substantially follow the curvature of the rigid part 1.

Referring to the sectional view of FIG. 5 the nail retainers 22 each comprises a lower part 24 and an upper part 25. The lower part 24 is bathtub-shaped, a surrounding wall 26 enclosing an inner space 27. The upper part 25 is substantially shaped like a solid box; the three nail holes 23 extending through it. Hereby, the lower part 24 forms counter-sinking on which nail heads 28 of conventional nails 29 inserted into a hoof abut. The nail retainer 22 shown in FIG. 5 is shown with a dotted line in FIG. 4.

Similar to the resilient parts 13, 14 described above the nail retainers 22 are manufactured from a moulded resilient plastic material, preferably polyurethane.

Hereby, the nail retainers 22 are arranged such that a nail 29 can be connected to a hoof of a horse through a nail hole 23 without touching any portion of the rigid part 1. Thus, the nail retainers 22 are arranged to form an intermediate resilient layer between the nail 29 and the rigid part 1.

The nail retainers 22 are preferably manufactured from the same resilient material as the resilient parts 13, 14 described above. The considerations regarding Young's modulus E described above in relation to the resilient parts 13, 14 equally hold true for the nail retainers 22. Manufacture of the horseshoe according to the present embodiment is preferably carried out as follows. First, the rigid part 1 is manufactured, preferably by means of drop-forging, providing holes and cut-outs for the resilient parts 13, 14, nail retainers 22 etc. In a subsequent process the rigid part 1 is positioned in one or more forms, and the nail retainers 22 and the resilient parts 13, 14 are simultaneously moulded from resilient material, e.g. polyurethane, onto the rigid part 1. Drop-forging the rigid part 1 involves rather large tolerances of the horseshoe. For this reason it is advantageous to mould the nail retainers 22 and the resilient parts 13, 14 in a number of smaller forms. Hereby, it is made easier to mould the parts, placing the rigid part 1 sequentially in the smaller forms.

Referring to FIG. 2 the upper sections 11, 12 above the resilient parts 13, 14 comprise cut-outs in the form of through-going holes 15, each having a central wing 16. Each wing 16 is slightly sunk from the upper surface 5 to allow for the resilient material to be distributed around the wing 16 such as to use the wing 16 as a barb in order to firmly retain the respective resilient parts 13, 14 to the respective upper sections 11, 12. Adhering forces between the resilient material and the material of the rigid part 1 also contribute to securing the resilient parts 13, 14 and the nail retainers 22 to the rigid part 1.

While moulding the resilient material the holes 17, 18 are also filled with the resilient material in order to provide further shock absorption in cases in which modax are not used. If modax are used, the resilient material is drilled out before positioning of the modax.

Alternatively, the nail retainers 22 may be manufactured separately from the rigid part 1, e.g. in the form of separate moulded elements, which are positioned into the openings after being cured. In this case, the separately manufactured nail retainers should be shaped to fit firmly into the openings 21. The set of parts according to the second aspect of the invention thus also comprises an embodiment in which nail retainers are provided separately from the rigid part.

When attaching the horseshoe of the present embodiment to a hoof of a horse the horseshoe is first properly positioned by means of the toe clips 19, 20. Then a suitable number of horseshoe nails 29 are inserted into the pre-shaped nail holes 23, through the rigid part 1 and into the hoof.

The invention is not limited to the use of four nail retainers. Any other suitable number may be used. Also, any suitable number of nail holes of the nail retainers may be present in other embodiments.

### LIST OF REFERENCE NUMERALS

1 Rigid part

2 Front portion

3, 4 Backward facing branch

5 Upper surface

6 Lower surface

6a Slot

7, 8 Cut-outs

9, 10 Lower section

11, 12 Upper section

13, 14 Resilient part

13a, 14a Lower surface

15 Through-going hole

16 Wing

17, 18 Hole

19, 20 Toe clip

21 Opening

22 Nail retainer

23 Nail hole

24 Lower part of nail retainer

25 Upper part of nail retainer

26 Surrounding wall

27 Inner space

28 Nail head

29 Nail

1. A shock-absorbing horseshoe comprising
a rigid part with an upper surface adapted for abutment with a hoof of a horse and a lower surface adapted for impacting with the ground or substratum on which the horse moves, said rigid part forming one rigid body shaped substantially as a conventional horseshoe according to a hoof of a horse with two backward facing branches towards a tail of the horse, wherein
cut-outs of the rigid part are formed at the end of each branch such that a lower section of each backward facing branch is shorter than an upper section measured in the backward direction, and
a resilient part is provided at a rear edge of each backward facing branch, such as to -extends backward beyond rear edges of each said lower section and ends at rear edges of the respective upper section, and
each said resilient part is wedge-shaped, a lower surface (13a, 14a) of each said resilient part at each said rear edges of said lower sections being in alignment with an underside of said lower sections and extending downward and backward toward said rear edges of said upper sections,
such as to provide resilience at the backward or heel part of the horseshoe, the resilient parts initially abutting the ground during use, and to obtain a shock-absorbing effect in the rear part of the horseshoe, which is the part of the horseshoe first hitting the substratum.

2. A horseshoe according to claim 1, wherein said rigid part is a solid, integrally formed body.

3. A horseshoe according to claim 1, wherein said rigid part in each said upper section above the respective resilient part comprises cut-outs forming barbs adapted for firmly retaining said resilient parts to each said upper section.

4. (canceled)

5. A horseshoe according to claim 1, wherein each said lower surface of said resilient parts extends downward in an angle of 2-10° in relation to said underside of the respective lower section.

6. A horseshoe according to claim 1, wherein said resilient parts comprise a moulded resilient plastic material.

7. A set of parts adapted to be assembled to form a shock-absorbing horseshoe, comprising
a rigid part adapted for abutment with a hoof of a horse and with the ground, said rigid part forming one rigid body with two backward facing branches and having a number of openings extending from a lower to an upper surface of said rigid part,
wherein it further comprises
a number of resilient nail retainers adapted to be embedded in said openings of said rigid part, each nail retainer comprising at least one nail hole and being arranged to form an intermediate resilient layer between a nail guided through said nail hole and said rigid part.

8. A horseshoe according to claim 7, wherein said nail retainers are arranged such that a nail can be connected to a hoof of a horse through one said nail hole without being in contact with any portion of said rigid part.

9. A horseshoe according to claim 7, wherein said nail retainers comprise a moulded resilient plastic material.

10. A horseshoe according to claim 7, wherein said openings in said rigid part and said nail retainers follow a curvature of said horseshoe.

11. A horseshoe according to claim 7, wherein each nail retainers each comprise a section for abutting a head of a nail (29), said section being sunk in said nail retainer.

12. A horseshoe according to claim 7, wherein said nail retainers are embedded in said openings.

13. A horseshoe according to claim 12, wherein said horseshoe is according to any one of claim 1, said resilient parts and nail retainers being manufactured from the same resilient material.

14. A horseshoe according to claim 13, wherein said horseshoe, besides said resilient parts and said nail retainers, does not comprise any resilient elements.

15. A horseshoe according to claim 1, wherein the proportion of Young's modulus of the rigid part in relation to Young's modulus of the resilient parts (13, 14) is at least 100.

16. A horseshoe according to claim 1, wherein Young's modulus of the rigid part lies within an interval of 80-250 GPa.

17. A horseshoe according to claim 1, wherein Young's modulus of the resilient parts is 10-700 MPa.

18. A horseshoe according to claim 1, wherein the thickness of each resilient part is 1.25-2.5 times larger than the thickness of the respective parts of the upper sections of the rigid part.

19. A horseshoe according to claim 1, wherein from the rear edge of the horseshoe each resilient part extends 0.15-0.4 of the linear distance from the rear edge to the front edge of the horseshoe.

20. Use of a horseshoe according to claim 1 mounted on a horse's hoof, said resilient parts providing resilience at the backward or heel part of the horseshoe, the resilient parts initially abutting the ground during use, and to obtain a shock-absorbing effect in the rear part of the horseshoe.
